(19) United States
(12) Patent Application Publication
(10) Pub. No.: US 2012/0091864 A1
(43) Pub. Date: Apr. 19, 2012

(54) Magi - Magnetic invention

(75) Inventor: Peter T. Eaton, Clarksville, VA (US)

(73) Assignee: Scott Gregory Eaton, Rockville, MD (US)

(21) Appl. No.: 13/137,413

(22) Filed: Aug. 12, 2011

Related U.S. Application Data
(60) Provisional application No. 61/403,064, filed on Sep. 10, 2010.

(51) Int. Cl. H02K 21/12; H02K 11/00

(52) U.S. Cl. 310/68 B; 310/156.01

(57) ABSTRACT

A Magnetic Invention, or a magnetic field power convertor, provided with a driveshaft inserted transversely through a custom rare-earth neodymium magnet. This combination is then mounted inside a cylindrical electromagnet. Two sets of coils, referred to as the motor coils and the generator coils, are designed with a custom-built proximity switch and pulser system. The duration and amount of the input pulse and energy are minute and the output energy from the Magnetic Invention occurs continuously throughout the entire cycle.

### CROSS-REFERENCE TO RELATED APPLICATIONS

This Non-Provisional utility patent application cross-references and refers to both the “Magnetic Field Power Convertor” application 20040100099 filed May 27, 2004 and the subsequent Provisional patent application 61/403,064 filed Sep. 10, 2010. This is to indicate the relationship of the following Non-Provisional Patent and the same exact core idea and concept, as first filed for the exact same basic integral structure, design, and configuration of said invention. The previous applications were filed and petitioned with appeal by the inventors with no patent awarded due to the unique nature of this invention.

| | |
|---|---|
| United States Patent Application | 20040100099 |
| Magnetic Field Power Convertor | A1 |
| Eaton, Peter T. ; et al. | May 27, 2004 |
| United States Provisional Patent | 61/403,064 |
| Application | |
| Kind Code | A1 |
| Eaton, Peter T. ; et at. | Sep. 10, 2010 |

### BACKGROUND OF THE INVENTION

1. Field of the Invention

The present invention relates to a magnetic generator provided with a Rare-Earth magnet-equipped transverse axle inside of a coil-equipped electromagnet and, more particularly, to a pulser-equipped generator for highly efficient production of electrical current.

2. Background Information of the Invention

By this invention, which we call “Magi”, we have invented a device of new, unprecedented, and unique design that produces electric current in a unique and highly efficient manner. The MAGI Magnetic Invention is a unique magnetic field power convertor that operates in the energy production field of endeavor. This generator has a design that operates as and electricity producing machine, yet, is independent of any standard power sources—such as hydro, nuclear, solar, or burning of fossil fuels. There are many inherent inefficiencies and problems with the conventional electricity producing generators in operation today. The most obvious problems are the dangers in nuclear reactors, the reliance on foreign oil, domestic oil limitations, coal emissions and the unreliability of solar/fuel cell solutions. This invention represents a completely harmless way to produce electricity without any of the challenges currently facing electricity generation firms today.

### BRIEF SUMMARY OF THE INVENTION

A standard driveshaft is inserted thru a custom-built neodymium permanent magnet and the combination is mounted inside a cylindrical electromagnet such that they are transverse (perpendicular) to the longitudinal axis of the electromagnet.

A custom-built Pulser System, consisting of a proximity switch and a commercial relay, delivers a brief DC direct current pulse from a standard battery to the outer set of electromagnet coils. This occurs when a metal stud, attached to the periphery of cam, mounted on the transverse driveshaft, triggers the proximity switch.

The arrangement of all the components is designed so the pulse is delivered as the edge of the permanent magnet passes closest to the coils. The repulsive magnetic force of the permanent magnet and the field created in the electromagnet coils repel each other and the permanent magnet rotates with its' integral driveshaft. This part of “Magi” we refer to as the Motor.

An identical set of electromagnetic coils is wound around the electromagnet cylinder inside of and con-centric with the Motor coils which respond to the rotating permanent magnet by generating AC alternating current continuously. . This part we refer to as the Generator.

“Magi” is unique because the duration of the input energy from the battery is less than 1% of the duration of the rotational cycle of the permanent magnet while the output from the Generator occurs continuously during the entire duration of each cycle. Test results indicate that the Coefficient of Power—output/input—is approximately three (3). This is only possible if the enormous amount of energy stored in the neodymium permanent magnet has its' electrons aligned by being magnetized and they are released as output energy by the “Magi” components and their unique arrangement.

### BRIEF DESCRIPTION OF THE DRAWINGS

The enclosed drawings represent both sectional views and partial views of the core configuration of MAGI—the motor and the generator. We have included a clone/medusa figure in these drawings to further claim the capability for redundant MAGI to be utilized and perform useful work simply by placing them in magnetic proximity to MAGI.

FIG. 1) is a mechanical drawing which provides the side view, cut away;

FIG. 2) is a detailed drawing which provides full scale and MAGI in motion;

FIG. 3) is a mechanical drawing which provides electrical details—(front/top/side view);

### DETAILED DESCRIPTION OF THE INVENTION

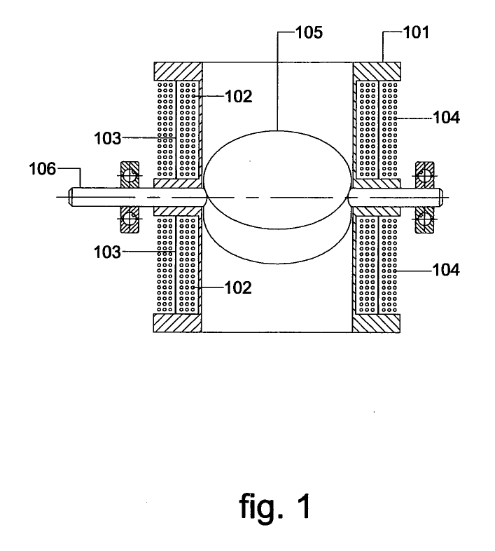

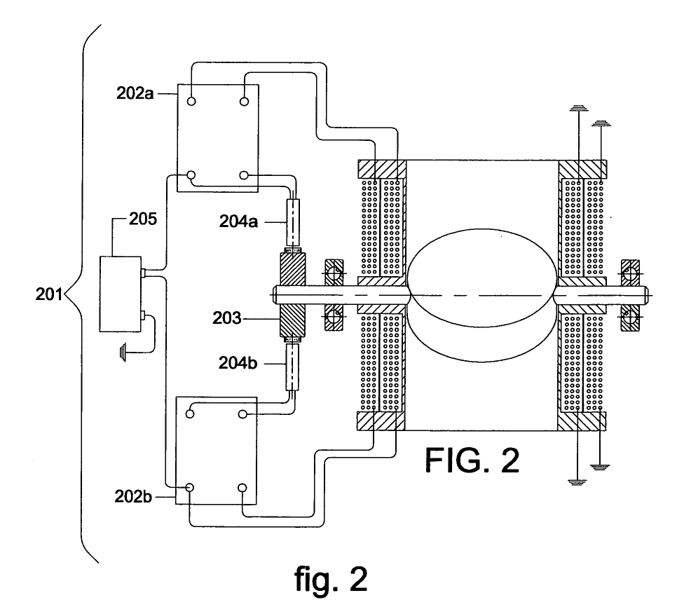

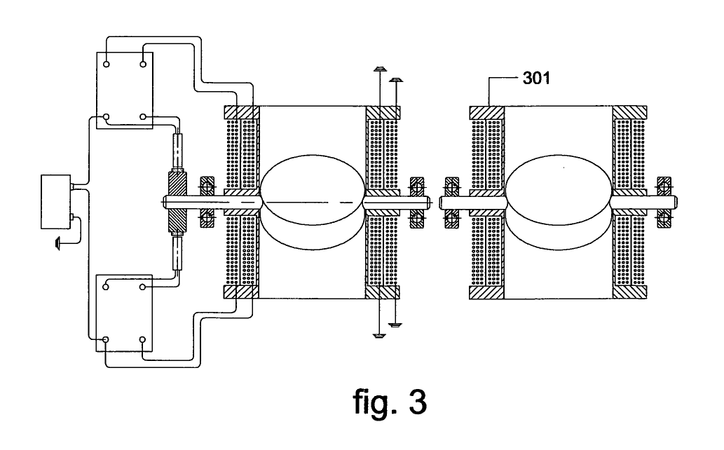

Our invention, MAGI—the Magnetic Invention—which we refer to as “Magi”, is a unique arrangement of three major components: the electromagnet, the permanent magnet, and the Pulser System—which are shown in FIG. 1, FIG. 2, and FIG. 3.

The electromagnet consists of a non-metallic, thin-walled, cylindrical tube (FIG. 1-101) that has copper magnet wire coils wrapped around it's periphery in layers, as shown in (FIG. 1-102 and FIG. 1-104). The distance along the cylinder from the top coil to the bottom coil is equal to the diameter of the permanent magnet (FIG. 1-105) to assure maximum repelling of the two. Magi will operate regardless of magnet wire gauge, or number of layers, but we found 20 gauge and five layers fairly optimum for the small model we used.

The first layer of coils are wound starting at the top, clockwise down to the driveshaft ,jump across the driveshaft space, then counterclockwise down to the bottom, then backup to the top in the same pattern to form the second layer. Continue this process with the one single continuous wire for additional layers desired.

This set of coils is wired to the work as output current with the starting point as the positive side and the end of the coils wired to ground—so this becomes what we refer to as the Generator (FIG. 1-102). This set of coils is done first so they are as close as possible to the permanent magnet (FIG. 1-105) inside the cylinder which we found to be very important to maximize generator output.

A layer of non-metallic material (FIG. 1-103) is wrapped around the Generator coils to isolate them electrically and magnetically from a second set of coils that is then wrapped around the cylinder in the same manner as described above for the Generator. However, this second set of coils are all wrapped clockwise, both above and below the driveshaft (FIG. 1-106). We found this set of coils to be unaffected by their further distance from the permanent magnet. This length of magnet wire is wound over the first, forming what is referred to as the Motor (FIG. 1-104). These coils are wired to the battery, through the Pulser System, to provide the input current pulses. The starting point is connected to the Relay and the end point is wired to ground. The new, unique Pulser System is shown in (FIG. 2), and consists of: a custom-built cam mounted on the driveshaft with a metallic “target button” attached to it's periphery ; The “Pulsing System” features two (2) Relays (FIG. 2-202a and FIG. 2-202b): a Targeting Disc (FIG. 2-203) mounted to the Bearing Mounted Driveshaft, and two (2) Proximity Switches (FIG. 2-204a and FIG. 2-204b) that are aligned with specific points on the Targeting Disc. Powering the “Pulsing System” is an external Power Source (FIG. 2-205).

When the invention is energized an initial surge of energy from the Power Source is delivered to the Generator, exciting the coils and causing a rapid, rotational movement of the Permanent Magnet. The rotation of the Permanent Magnet drives the Bearing Mounted Shaft which, in turn, rotates the Targeting Disc. As the specific points on the Targeting Disc pass by one of the Proximity Switches, the Proximity Switch the closes and allows a momentary pulse of current flow to one of the Relays. Upon receiving current from one of the Proximity Switches, the Relay closes, allowing a pulse of energy to pass to the Motor. This repeating process, alternating between Proximity Switches and Relays, allows a sustainable flow of energy to be the applied to the motor and provides a continuous operation of the unit.

A unit duplicating the original, consisting of the components included in FIG. 1, (FIGS. 101-1, 101-2, 101-3, 101-4, 101-5, and 101-6) is referred to as the Clone (FIG. 3-301). When this Clone is placed in close proximity to the original system shown in FIG. 2 (FIG. 2, FIGS. 2-202, 2-203, 2-204, and 2-205) the Clone tends to auto-operate without benefit of a power source other than the magnetic field generated by the original unit. As the magnet in the Clone rotates, alternating current is generated. The voltage of this current is only slightly less than the alternating current generated by the original system.

A standard proximity switch mounted on a nearby bracket such that it senses the target button each time it passes by; a standard commercial Relay (we used a Kyoto 00100) that is activated by a signal from the proximity switch—which closes it's internal switch briefly to allow a pulse of direct current to flow to the Motor coils from the battery. This DC direct current input is unprecedented because of the circuitry of the Pulser System so it must be displayed on an oscilloscope. The shape and spacing of the input pulses show they are only about 1% of each rotational cycle—compared to the output a.c. current which is generated 100% of each rotational cycle.

What is claimed is:

1) a Magnetic custom-built electromechanical device that consists of a unique arrangement of components that exhibits a Coefficient of Power>1.0. Because of the unique combination of: a) neodymium magnets b) mounted transversely on the axle c) axle is integral and is attached directly through the center of said magnet d) pulser system for very short electrical pulses e) nature of the rare earth raw material provides much more efficiency and potential extraction of energy, the result is a device which by its' unique design provides much more useful work and utility than any other similar device;

2) a Magnetic custom-built electromechanical device which includes a custom-built permanent magnet mounted, transversely, on a driveshaft that is inserted inside a custom-made non-metallic cylinder such that it is transverse (perpendicular) to the longitudinal axis of the cylinder;

3) The cylinder identified in claim #2 has magnetic wires wrapped around it's periphery to form coils such that they convert the cylinder into a custom-built electromagnet;

4) an inner set of the coils identified in claim #3 ,that is closest to the central axis, produces the electric current output of the device and is therefore called the “Generator”;

5) an outer set of the coils identified in claim #3 , that is con-centric with the inner coils identified in claim #4 , and is furthest from the central axis, receives input current from the battery and is therefore called the “Motor”;

6) The input current to the Motor identified in claim #5 is delivered in brief pulses that are controlled by a custom-built arrangement of components we call the “Pulser” System. The input current is used only in brief pulses and output current is generated continuously and by extracting energy from its' permanent magnet;

7) the Pulser System identified in claim #6 includes: a custom built cam mounted on the driveshaft, a proximity switch mounted near it that is activated by a target on the cam, and a commercial Relay that is activated by the proximity switch which closes its' switch allowing it to deliver the input current in brief pulses to the Motor coils;

8) when additional Generators, identical to the primary Generator identified in claim #4, are placed in close proximity to the device identified in claim #1, and are not connected to the battery or any other power source they become immersed in the EMF of the device and generate output current similar to that generated by the primary Generator while causing only minor decrease in the output of the primary Generator even;
